(19) United States
(12) Patent Application Publication
(10) Pub. No.: US 2016/0230068 A1
(43) Pub. Date: Aug. 11, 2016

(54) ANIONIC POLYSACCHARIDE POLYMERS FOR VISCOSIFIED FLUIDS

(71) Applicant: BAKER HUGHES INCORPORATED, Houston, TX (US)

(72) Inventors: Lawrence N. Kremer, The Woodlands, TX (US); Charles D. Armstrong, Tomball, TX (US); Stanley Gunawan, The Woodlands, TX (US)

(73) Assignee: BAKER HUGHES INCORPORATED, Houston, TX (US)

(21) Appl. No.: 15/134,064

(22) Filed: Apr. 20, 2016

Related U.S. Application Data
(62) Division of application No. 14/218,212, filed on Mar. 18, 2014.

(51) Int. Cl. C09K 8/035; C09K 8/64; C09K 8/588

(52) U.S. Cl. CPC C09K 8/035; C09K 8/588; C09K 8/64; C09K 2208/24; C09K 2208/26

(57) ABSTRACT

Anionic polysaccharide polymers, derived from kelp may be used in additive compositions, and fluid compositions for viscosifying a base fluid, such as an aqueous-based fluid, a non-aqueous based fluid, and combinations thereof. In a non-limiting embodiment, a breaker additive may be used to break the viscosity of the viscosified fluid composition, which may have or include a breaker agent to break the viscosified fluid composition.

### CROSS-REFERENCE TO RELATED APPLICATION

This application is a divisional application of U.S. patent application Ser. No. 14/218,212 filed Mar. 18, 2014, incorporated herein in its entirety by reference.

### TECHNICAL FIELD

The present invention relates to additive compositions, fluid compositions, and methods for using at least one anionic polysaccharide polymer derived from kelp in a base fluid, such as but not limited to a drilling fluid, a completion fluid, a fracturing fluid, an injection fluid, and combinations thereof.

### BACKGROUND

In the recovery of hydrocarbons from subterranean formations, viscosifying agents are used to increase the viscosity of the base fluid or ‘thicken’ the fluid. A non-limiting reason for thickening the fluid is to prevent inorganic components from settling out of the base fluid, such as clay, proppants, etc. The viscosifier may be presented in a powder form, or in a slurried form in a hydrocarbon such as diesel, and is then hydrated. After hydration, the viscosifier may be cross-linked to further thicken the fluid. Non-limiting examples of polymers/polysaccharides used as viscosifying agents may be or include guar and derivatives of guar, such as hydroxypropyl guar (HPG), carboxymethylhydroxypropyl guar (CMHPG), carboxymethyl guar (CMG), hydrophobically modified guar; galactomannan gums; xanthan gum; cellulose (e.g. hydroxymethyl cellulose, hydroxyethylcellulose, and the like); and combinations thereof.

Numerous chemical additives such as antifoaming agents, acids or bases, or other chemicals may be added to provide appropriate properties to the fluid after the viscosifier has been hydrated. Other additives commonly included are cross-linkers, viscosity stabilizers, activators for crosslinking, shear recovery agents, hydration enabling agents, clay stabilizers, and combinations thereof. Generally, a viscosity stabilizer may retard the polymer degradation from the effects of temperature, shear, and iron exposure. A clay stabilizer may prevent the swelling or migration of the clays in the formation.

Viscosified fluids are routinely used to treat and fracture subterranean formations to increase production from these formations. Typically, the fluid is prepared or mixed at the surface by combining a number of liquid additive streams with a hydrated polymer fluid. The resulting fluid composition is then pumped downhole with sufficient pressure to accomplish the treatment. In certain cases, the fluid may be used to transport proppant or other additives into the formation. The fluid must have sufficient viscosity to transport any included solids, such as proppant; however, it cannot be so viscous that it cannot be economically pumped downhole.

The crosslinkers ‘crosslink’ the polymers by chemically connecting or bonding the polymer chains in the fluid, which increases the viscosity of thickened or viscosified fluids. Well-known crosslinkers include boron, zirconium, and titanium-containing compounds. In many cases, the use of a crosslinker alone causes a very rapid increase in the viscosity of the fluid and may present significant problems in terms of handling and pumping the viscosified fluid (i.e., the amount of horsepower required to pump the highly viscous fluid downhole is greater than that typically provided at the jobsite). To alleviate this problem, the crosslinking of the polymer may be delayed for a predetermined time. In this way, the fluid does not reach its full viscosity until it is downhole. Delay agents are commonly combined with the crosslinker prior to mixing the crosslinker with the polymer fluid and are used to delay the crosslinking until the crosslinker reaches a pre-determined condition, such as an amount of time, pH, temperature, location in the wellbore, and combinations thereof.

The delay agent may be a capsule that physically traps the crosslinker inside or physically sequesters the crosslinker. The capsule may dissolve after a predetermined condition to release the crosslinker. Alternatively, the crosslinker may be bound to or reacted with the delay agent. The release from the delay agent may occur after the pre-determined condition. The delay in the crosslinking reaction may be due to a ligand exchange between the crosslinker, the delay agent and the polysaccharide. In simplified terms, the delay may be determined by the time required by the crosslinker to “escape” from the delay agent and crosslink the polymer. Although the fluid additives, including crosslinker and delay agents, are typically provided in liquid form, in some cases the additives and polymer may be provided in a dry form.

These polymers and/or additives may be added to downhole fluids, such as fracturing fluids, drilling fluids, completion fluids, injection fluids, and combinations thereof. Drilling fluids are typically classified according to their base fluid. In water-based fluids, solid particles, such as weighting agents, are suspended in a continuous phase consisting of water or brine. Oil can be emulsified in the water, which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in- non-aqueous emulsion, a brine-in-oil emulsion, or a brine-in-non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

There are a variety of functions and characteristics that are expected of completion fluids. The completion fluid may be placed in a well to facilitate final operations prior to initiation of production. Completion fluids are typically brines, such as chlorides, bromides, and/or formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof. Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Completion fluids do not contain suspended solids.

Servicing fluids, such as remediation fluids, stimulation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations. A stimulation fluid may be a treatment fluid prepared to stimulate, restore, or enhance the productivity of a well, such as fracturing fluids and/or matrix stimulation fluids in one non-limiting example.

Hydraulic fracturing is a type of stimulation operation, which uses pump rate and hydraulic pressure to fracture or crack a subterranean formation in a process for improving the recovery of hydrocarbons from the formation. Once the crack or cracks are made, high permeability proppant relative to the formation permeability is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

The development of suitable fracturing fluids is a complex art because the fluids must simultaneously meet a number of conditions. For example, they must be stable at high temperatures and/or high pump rates and shear rates that can cause the fluids to degrade and prematurely settle out the proppant before the fracturing operation is complete. Various fluids have been developed, but most commercially used fracturing fluids are aqueous based liquids that have either been gelled or foamed to better suspend the proppants within the fluid.

Injection fluids may be used in enhanced oil recovery (EOR) operations, which are sophisticated procedures that use viscous forces and/or interfacial forces to increase the hydrocarbon production, e.g. crude oil, from oil reservoirs. The EOR procedures may be initiated at any time after the primary productive life of an oil reservoir when the oil production begins to decline. The efficiency of EOR operations may depend on reservoir temperature, pressure, depth, net pay, permeability, residual oil and water saturations, porosity, fluid properties, such as oil API gravity and viscosity, and the like.

EOR operations are considered a secondary or tertiary method of hydrocarbon recovery and may be necessary when the primary and/or secondary recovery operation has left behind a substantial quantity of hydrocarbons in the subterranean formation. Primary methods of oil recovery use the natural energy of the reservoir to produce oil or gas and do not require external fluids or heat as a driving energy; EOR methods are used to inject materials into the reservoir that are not normally present in the reservoir.

Secondary EOR methods of oil recovery inject external fluids into the reservoir, such as water and/or gas, to re-pressurize the reservoir and increase the oil displacement. Tertiary EOR methods include the injection of special fluids, such as chemicals, miscible gases and/or thermal energy. The EOR operations follow the primary operations and target the interplay of capillary and viscous forces within the reservoir. For example, in EOR operations, the energy for producing the remaining hydrocarbons from the subterranean formation may be supplied by the injection of fluids into the formation under pressure through one or more injection wells penetrating the formation, whereby the injection fluids drive the hydrocarbons to one or more producing wells penetrating the formation. EOR operations are typically performed by injecting the fluid through the injection well into the subterranean reservoir to restore formation pressure, improve oil displacement or fluid flow in the reservoir, and the like.

Examples of EOR operations include water-based flooding and gas injection methods. Water-based flooding may also be termed ‘chemical flooding’ if chemicals are added to the water-based injection fluid. Water-based flooding may be or include, polymer flooding, ASP (alkali/surfactant/polymer) flooding, SP (surfactant/polymer) flooding, low salinity water and microbial EOR; gas injection includes immiscible and miscible gas methods, such as carbon dioxide flooding, and the like. “Polymer flooding” comprises the addition of water-soluble polymers, such as polyacrylamide, to the injection fluid in order to increase the viscosity of the injection fluid to allow a better sweep efficiency by the injection fluid to displace hydrocarbons through the formation. The viscosified injection fluid may be less likely to by-pass the hydrocarbons and push the remaining hydrocarbons out of the formation.

Micellar, alkaline, soap-like substances, and the like may be used to reduce interfacial tension between oil and water in the reservoir and mobilize the oil present within the reservoir; whereas, polymers, such as polyacrylamide or polysaccharide may improve the mobility ratio and sweep efficiency, which is a measure of the effectiveness of an EOR operation that depends on the volume of the reservoir contacted by the injected fluid. Carbon dioxide (CO₂) injection is similar to water flooding, except that carbon dioxide is injected into an oil reservoir instead of water to increase the extraction of oil from the reservoir.

When performing a polymer-in-solution flooding process, a polymer may increase the viscosity of the water closer to that of oil, so that less bypassing or channeling of the floodwater may occur. Said differently, the mobility of the floodwater may be decreased to provide a greater displacement of the flood front.

The alkaline/surfactant/polymer (ASP) technique may have a very low concentration of a surfactant to create a low interfacial tension between the trapped oil and the injection fluid/formation water. The alkali/surfactant/polymer present in the injection fluid may then be able to penetrate deeper into the formation and contact the trapped oil globules. The alkali may react with the acidic components of the crude oil to form additional surfactant in-situ to continuously provide ultra low interfacial tension and free the trapped oil. With the ASP technique, polymer may be used to increase the viscosity of the injection fluid, to minimize channeling, and provide mobility control.

The recovery of the viscosified downhole fluids may be accomplished by reducing the viscosity of the fluid, so that it may flow naturally from the formation under the influence of formation fluids. ‘Formation fluid’ is defined herein to be any fluid produced from an oil bearing subterranean formation including but not limited to oil, natural gas, water, and the like.

Viscosified fluids and/or crosslinked gels may require viscosity breakers (also known as breaker additives) to reduce the viscosity or “break” the viscosity or gel. Enzymes, oxidizers, and acids are known polymer viscosity breakers. Although oxidizers and acids may be used, oxidizers and acids may be ineffective at low temperature ranges from ambient temperature to about 130° F. (about 54° C.). Moreover, common oxidizers and/or acids may not break the polysaccharide backbone into monosaccharide units; the breaks may be non-specific and create a mixture of macromolecules which may still impart viscosity to the base fluid.

Enzymes are effective within a pH range, typically a 2.0 to 10.0 range, with increasing activity as the pH is lowered towards neutral from a pH of 10.0. Most conventional crosslinked fluids and breakers are designed from a fixed high crosslinked fluid pH value at ambient temperature and/or reservoir temperature. Optimizing the pH for a crosslinked gel is important to achieve proper crosslinked stability and controlled enzyme breaker activity. Non-limiting examples of conventional enzyme breaker systems include cellulose, hemi-cellulase, amylase, pectinase, and the like. The goal of the enzyme is to break the bonds that connect the monosaccharides into a polysaccharide.

It would be desirable if better or alternative viscosifying agents were designed to thicken fluids that are less toxic for the environment. When the viscosified fluid is a downhole fluid, better mechanisms of breaking or reducing the viscosity of the thickened fluid would also be desirable.

### SUMMARY

There is provided, in one form, a viscosifying additive composition for a fluid, such as but not limited to a drilling fluid, a completion fluid, a fracturing fluid, an injection fluid, and combinations thereof. The viscosifying additive may have or include at least one anionic polysaccharide polymer and at least one breaker agent. The anionic polysaccharide polymer(s) may be derived from a source, such as but not limited to, kelp.

There is provided, in a non-limiting form, a breaker additive composition for reducing the viscosity of a viscosified fluid. The viscosified fluid may be or include, but is not limited to, fracturing fluids, drilling fluids, completion fluids, injection fluids, and combinations thereof. The breaker additive may have or include at least two breaker agents where a first breaker agent is a B vitamin. A second breaker agent different from the first breaker agent may be or include an enzyme, an oxidizer, an acid, and combinations thereof.

There is further provided in an alternative non-limiting embodiment of a viscosified fluid composition that does not include a viscoelastic (VES) surfactant. The viscosified fluid composition may have or include a base fluid and at least one anionic polysaccharide polymer derived from a source selected from the group consisting of kelp. The base fluid may be or include, but is not limited to fracturing fluids, drilling fluids, completion fluids, injection fluids, and combinations thereof.

In an alternative embodiment, a method is described, which may include circulating a viscosified fluid composition into a subterranean reservoir wellbore. The viscosified fluid composition may have or include an effective amount of at least one polymer derived from at least one source, such as but not limited to kelp.

The anionic polysaccharide polymer appears to be a less toxic viscosifier for downhole fluids, and the viscosified fluid may be broken in a quicker manner with the aid of B vitamins in conjunction with the enzyme breakers.

### DETAILED DESCRIPTION

It has been discovered that an anionic polysaccharide polymer derived from a source, such as algae (also known as brown algae) may be used as a viscosifying additive to viscosify a base fluid. Such base fluids may be any fluid usable in a subterranean reservoir wellbore, such as but not limited to fracturing fluids, drilling fluids, completion fluids, injection fluids, and combinations thereof. The base fluid composition may be an aqueous fluid, a non-aqueous fluid, and combinations thereof. In a non-limiting embodiment, the base fluid may be an aqueous fluid. In another non-limiting embodiment, the viscosified fluid composition may be formed in the presence or the absence of a viscoelastic surfactant.

The anionic polysaccharide polymer may be or include, but is not limited to, alginate (also known as alginic acid or algin). Alginate is an anionic polysaccharide polymer distributed widely in the cell walls of brown algae or kelp. Alginate and other anionic polysaccharide polymers may bind with water to form a viscous gum. Alginate may be capable of absorbing 200-300 times its own weight in water. Structurally, alginic acid is a linear copolymer with homopolymeric blocks of (1-4)-linked β-D-mannuronate (M) and a C-5 epimer α-L-guluronate (G) residues, respectively, which are covalently linked together in different sequences or blocks. The monomers may appear in homopolymeric blocks of consecutive G-residues (G-blocks), consecutive M-residues (M-blocks), alternating M and G-residues (MG-blocks), and combinations thereof.

In a non-limiting embodiment, the anionic polysaccharide polymer(s) may have or include a functional group attached thereto, such as a sulfonate. The viscosifying additive may also have or include viscosity stabilizers, activators for crosslinking, shear recovery agents, hydration enabling agents, clay stabilizers, a second anionic polysaccharide different from the anionic polysaccharide derived from kelp, and combinations thereof. The second anionic polysaccharide may be or include, but is not limited to, peptin, xanthan gum, hyaluronic acid, chondroitin sulfate, gum Arabic, gum karaya, and gum tragacanth, and combinations thereof. ‘First’ and ‘second’ in regards to the anionic polysaccharide are used to distinguish one from the other and are not used to denote a particular order in which the anionic polysaccharides must be included in the additive and/or added to the base fluid. Moreover, the second anionic polysaccharide is optional and does not have to be included in the additive and/or added to the base fluid at all.

‘Effective amount’ of the anionic polysaccharide polymer is defined herein to mean any amount of the anionic polysaccharide polymer that may viscosify or thicken a base fluid to a pre-determined viscosity. The pre-determined viscosity of the base fluid may be dependent on shear rate in a non-limiting embodiment. For example, the higher the shear rate, the lower the viscosity of the base fluid needs to be; the lower the shear rate, the higher the viscosity needs to be. In a non-limiting embodiment, the anionic polysaccharide polymer(s) may be present in the viscosifying additive in an amount ranging from about 0.1 wt % (1000 ppm) independently to about 5.0 wt % (50,000 ppm) of the total fluid composition, alternatively from about 1 wt % (10,000 ppm) independently to about 2 wt % (20,000 ppm). In another non-limiting embodiment, the viscosity of the viscosified fluid composition may range from about 100 centistokes (cst) independently to about 50,000 cst, alternatively from about 500 cst independently to about 10,000 cst. As used herein with respect to a range, “independently” means that any threshold may be used together with another threshold to give a suitable alternative range, e.g. about 0.1 wt % (1000 ppm) independently to about 1 wt % (10,000 ppm) is also considered a suitable alternative range.

In a non-limiting embodiment, the anionic polysaccharide polymers may form a hydrogel with water, which is a network of polymer chains that are hydrophilic where water is the dispersion medium. Hydrogels are tridimensional networks of hydrophilic polymers that are able to swell in water. The ability of the hydrogel to respond to external conditions, such as but not limited to temperature, pH, ionic strength, electric or magnetic fields, and the like depends on the nature of polymer chains within the hydrogel.

Within the hydrogel, the anionic polysaccharide polymer(s) may be cross-linked by a cross-linker, such as but not limited to gluteraldehyde, Ca⁺², Al⁺³, Fe⁺³, Ba⁺², Zr⁺⁴, Sn⁺⁴, Th⁺⁴, U⁺⁴, La⁺³, and combinations thereof. The crosslinker may be present in the viscosity additive and/or the viscosified fluid composition in an amount ranging from about 0.1 wt % independently to about 3 wt %, alternatively from about 0.2 wt % independently to about 2.5 wt %. In a non-limiting embodiment, the hydrogel may form by mixing a 2 wt % sodium alginate solution (or calcium alginate solution) into a 1 wt % calcium chloride solution. Other non-limiting cross-linking solutions may be or include aluminum chloride, iron chloride, and the like which are capable of generating the previously recited ions. The cross-linker may also function as a biocide in a non-limiting embodiment, such as glutaraldehyde, to reduce an amount of bacteria present in the viscosified fluid composition, the wellbore, or both. In another non-limiting embodiment, the crosslinker alginate beads may remove heavy metal ions from water or water-based/brine-based fluids.

Once the viscosifying additive is added to the base fluid, the result is a viscosified fluid composition and may be used in a downhole operation. Once the operation has been completed, the viscosity of the fluid composition may need to be reduced. Reducing the viscosity is defined to mean a decrease in viscosity. Alternatively, ‘reducing the viscosity’ may be degrading the anionic polysaccharide polymer within the viscosified fluid composition. Complete reduction of the viscosified fluid composition and removal of the broken viscosified fluid is desirable, but it should be appreciated that complete reduction down to base fluid-like viscosity and/or complete removal is not necessary for the breaker methods and breaker additive compositions discussed herein to be considered effective.

Success is obtained if more of the anionic polysaccharide polymer is reduced and/or removed using the breaker agent or breaker additive than in the absence of the breaker agent or breaker additive. Alternatively, the methods described are considered successful if a majority of the anionic polysaccharide polymer is reduced and/or removed using the breaker agent or breaker additive than in the absence of the breaker agent or breaker additive. ‘Effective amount’ of the breaker agent is defined herein to mean any amount of the breaker agent that may reduce at least a portion of the anionic polysaccharide polymer such that the dissolved portion may be removed from the hydrocarbon reservoir wellbore. ‘Breaker’ or ‘breaking’ is defined herein to refer to the reduction of viscosity of the viscosified fluid composition.

A breaker additive may be added to or included in the viscosified fluid composition for reducing the viscosity of the fluid composition. Such breakers are called ‘internal’ breakers because they travel with the viscosified fluid ‘internally’ and break the fluid on a delayed basis from within. The breaker additive may be added to the base fluid when forming the viscosified fluid composition, or the breaker additive may be added to the viscosified fluid composition when the additive is needed to reduce the viscosity of the fluid composition. Adding the breaker additive to the viscosified fluid composition may occur by circulating the breaker additive into the subterranean reservoir wellbore before, after, or at the same time as the viscosified fluid composition; injecting the breaker additive into the subterranean reservoir wellbore before, after, or at the same time as the viscosified fluid composition; and combinations thereof. If the breaker additive is contacted with the viscosified fluid composition separately after the viscosified fluid has accomplished its task, it is termed an ‘external’ breaker.

The breaker additive may include breaker agents, delay agents, and combinations thereof. The viscosity of the viscosified fluid composition may be completely broken within a specific period of time after completion of the operation, which depends on the pH and temperature of the formation. A completely reduced fluid means one that may be flushed from the formation by the flowing formation fluids and/or formation pressures.

The breaker agent may be or include at least one of an enzyme, an oxidizer, an acid, a B vitamin, and combinations thereof. Oxidizers and acids are well known to those skilled in the art of breaking viscosified fluids. In a non-limiting embodiment, two or more breaker agents may be used, such as an enzyme and a B vitamin; an oxidizer and a B vitamin; two types of B vitamins; and the like. The breaker additive may be stable in a pH range of about 2.0 to about 12 and remain active at a pH above about 8.0. The temperature range for the stability of the enzyme may range from about 50° F. (about 10° C.) independently to about 180° F. (about 82° C.).

An enzyme is a biological catalyst, which lowers the activation energy of a particular reaction, which increases the rate of the particular reaction. Non-limiting examples of the enzymes may be or include cellulases, hemi-cellulases, amylases, alginases, pectinases, hydrolases, oxidases, and combinations thereof. Non-limiting examples of the alginases may be or include alginate lyase (or eliminase), endo-alginate hydrolase, and combinations thereof. The alginases may be synthetically produced, or may be obtained from an organic species, such as but not limited to Asteromyces cruciatus, Corollospora intermedia, Dendryphiella saline, Dendryphiella arenaria, Bacillus circulans, and the like. Alginases may catalyze the chemical reaction of an elimination by cleavage of a polysaccharide containing a beta-D-mannuronate residue, a terminal alpha-L-guluronate group, and the like. The alginase may be specific to degrade (e.g. hydrolyze) at least 70% of the alginate, or from about 80% independently to about 99.9% of the alginate, alternatively from about 90% independently to about 95% in a non-limiting embodiment.

Alginate molecules may be degraded using the enzyme, such as an alginase enzyme complex in a non-limiting embodiment, which is stable at temperatures above at least 100 F, alternatively above 150 F, or from about 130 F independently to about 250 F in another non-limiting embodiment. The enzyme complex may also be used to reduce the viscosity of the viscosified fluid composition having the anionic polysaccharide polymer. Alternatively, the enzyme complex may be used to break any anionic polysaccharide polymer (e.g. alginate) based formation damage, such as drilling filter cakes and filtrates, or to remove filter cakes present in processing equipment.

‘Filter cake’ is a residue deposited on a permeable medium when a fluid, such as a drilling fluid, is forced against the permeable medium under pressure. A filtrate is the liquid that passes through the permeable medium and leaves the cake on the permeable medium. Cake properties, such as cake thickness, toughness, slickness and permeability are important because the filter cake that forms on permeable zones in the wellbore may cause stuck pipe and/or other drilling problems. A certain degree of filter cake buildup is desirable to isolate formations from drilling fluids.

In the instance where at least one breaker agent is an enzyme, the breaker additive may include at least one cofactor to increase the rate of reducing the viscosified fluid composition by the enzyme(s). ‘Cofactor’ is defined herein to be a non-protein chemical compound that may assist or be required for an enzyme to function optimally or properly. A cofactor binds to a site of the enzyme, which is not usually the same site as a substrate; enzymes catalyze reactions involving the substrate. A non-limiting example may be an alginate binding to an enzyme and a cofactor binding to a separate site of the enzyme. A non-limiting example of the cofactor may be or include a cobalamin. The B vitamin(s) may be or include, but are not limited to B1 (thiamine), B2 (riboflavin), B12 (cobalamin), and combinations thereof. As defined herein, vitamin B12 represents all potentially biologically active cobalamins. Non-limiting examples of the biologically active cobalamins may be or include, but are not limited to 5′-deoxyadenosylcobalamin, methylcobalamin, hydroxocobalamin, cyanocobalamin (also known as vitamin B12), and combinations thereof.

In an alternative non-limiting embodiment, the B vitamin may break the viscosified fluid in the absence of an enzyme; in other words, the B vitamin may function as the breaking agent, alone or at least in the absence of an enzyme that would otherwise utilize a B vitamin cofactor, to break the viscosified fluid composition. Although the inventors do not wish to be bound to a specific theory, it is thought that the B vitamin, when not binding to an enzyme as a cofactor, may be converted into a form having a positive (+) site and a negative (−) site. The converted form may hydrolyze the ether linkages of the alginate and break the alginate into its substituent sugars.

The B vitamin(s) may be present in the breaker additive and/or the viscosified fluid composition in an amount ranging from about 0.005 wt % (50 ppm) independently to about 1 wt % (10,000 ppm), alternatively from about 0.01 wt % (100 ppm) independently to about 0.1 wt % (1,000 ppm) of the total viscosified fluid composition. Non-limiting combinations of the B vitamins may be or include B1 and B2; B1 and B12; B2 and B12; and B1, B2, and B12. However, particular B vitamin combinations may vary depending on the temperature and/or pressure of the viscosified fluid composition and/or the subterranean reservoir wellbore.

In a non-limiting embodiment, the viscosified fluid composition and/or the breaker agent may include solid particles, which range in size from about 10 nm independently to about 2500 microns, alternatively from about 100 nm independently to about 2000 microns. The solid particles may be or include, but are not limited to, ceramic beads, glass, sand, clay, walnut shell fragments, aluminum pellets, nylon pellets, nanoparticles of the beforementioned, other nanoparticles, and the like. The solid particles may be proppant particles in a non-limiting embodiment. The B vitamins may be configured to at least partially attach to the solid particles. ‘Attach’ is defined herein to mean a physical attachment (e.g. electrostatic forces) by adsorbing onto the surface of the solid particles, or a chemical attachment (e.g. a functional group of the B vitamin is covalently bonded to the solid particles). In the instance of a chemical attachment, the functional group on the B vitamin must not deactivate the B vitamin activity.

In a non-limiting embodiment, the B vitamins may be attached to the solid particles at the time of mixing the solid particles into the breaker additive and/or fluid composition. Alternatively, the B vitamins and the solid particles may be separately added to the breaker additive and/or fluid composition.

In a non-limiting embodiment, the viscosified fluid composition may be circulated into a subterranean reservoir wellbore. The viscosity of the viscosified fluid may be reduced by the methods described above. In an alternative embodiment, an amount of bacteria present in the viscosified fluid composition, the wellbore, or both may be at least partially reduced by the viscosifying additive present in the viscosified fluid composition, such as but not limited to a cross-linker within the viscosifying additive. In another alternative embodiment, the anionic polysaccharide polymer-crosslinked beads may remove heavy metals from the fluid composition, the wellbore, or both.

In the foregoing specification, the invention has been described with reference to specific embodiments thereof, and has been described as effective in providing methods and compositions for viscosifying a base fluid with an anionic polymer derived from kelp; as well as breaking the viscosified fluid composition with a B vitamin and/or other breaking agent. However, it will be evident that various modifications and changes can be made thereto without departing from the broader spirit or scope of the invention as set forth in the appended claims. Accordingly, the specification is to be regarded in an illustrative rather than a restrictive sense. For example, specific anionic polymers, anionic polymer sources, base fluids, breaker agents, B vitamins, crosslinkers, solid particles, and the like falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the viscosifying additive composition for a fluid, such as but not limited to a drilling fluid, a completion fluid, a fracturing fluid, an injection fluid, and combinations thereof, may consist of or consist essentially of at least one breaker agent and at least one anionic polysaccharide polymer derived from a source, such as but not limited to, kelp.

The breaker additive composition for reducing the viscosity of a viscosified fluid, such as fracturing fluids, drilling fluids, completion fluids, injection fluids, and combinations thereof may consist of or consist essentially at least two breaker agents where a first breaker agent is a B vitamin; a second breaker agent different may be different from the first breaker agent and may be or include an enzyme, an oxidizer, an acid, and combinations thereof.

The viscosified fluid composition that does not include a viscoelastic (VES) surfactant may consist of or consist essentially of a base fluid and at least one anionic polysaccharide polymer derived from a source selected from the group consisting of kelp; the base fluid may be or include, but is not limited to fracturing fluids, drilling fluids, completion fluids, injection fluids, and combinations thereof.

The method may consist of or consist essentially of circulating a viscosified fluid composition into a subterranean reservoir wellbore; the viscosified fluid composition may have or include an effective amount of at least one polymer derived from at least one source, such as but not limited to kelp.

The words “comprising” and “comprises” as used throughout the claims, are to be interpreted to mean “including but not limited to” and “includes but not limited to”, respectively.

What is claimed is:

1. A method for viscosifying a fluid comprising:
circulating a viscosified fluid composition into a subterranean reservoir wellbore; where the viscosified fluid composition comprises:
a non-aqueous fluid; and
at least one first alginate anionic polymer derived from kelp in an amount effective to viscosify the non-aqueous fluid.

2. The method of claim 1, where the viscosified fluid composition further comprises a breaker agent, and the method further comprises at least partially reducing the viscosity of the viscosified fluid composition with the at least one breaker agent.

3. The method of claim 2, where the at least one breaker agent is selected from the group consisting of an enzyme, a B vitamin, an oxidizer, an acid, and combinations thereof.

4. The method of claim 1, where the viscosified fluid composition comprises a base fluid selected from the group consisting of fracturing fluids, drilling fluids, completion fluids, injection fluids, and combinations thereof.

5. The method of claim 1, where the effective amount of the first alginate anionic polysaccharide polymer ranges from about 0.1 wt % to about 5 wt % of the total fluid composition.

6. The method of claim 1 where the viscosified fluid composition further comprises water, and where the method further comprises:
forming a hydrogel by contacting the at least one first alginate anionic polymer with the water present in the viscosified fluid composition.

7. The method of claim 6 where the at least one first alginate anionic polymer is crosslinked within the hydrogel.

8. The method of claim 1 further comprising viscosifying the non-aqueous fluid with a surfactant.

9. A breaker additive composition for reducing the viscosity of a viscosified fluid selected from the group consisting of fracturing fluids, drilling fluids, completion fluids, injection fluids, and combinations thereof; where the breaker additive comprises at least two breaker agents; where a first breaker agent is a B vitamin; where a second breaker agent is different from the first breaker agent; and where the second breaker agent is selected from the group consisting of an enzyme, an oxidizer, an acid, and combinations thereof.

10. The breaker additive of claim 9, further comprising solid particles; and where the at least one B vitamin is attached to the solid particles.

11. The breaker additive of claim 9 where the breaker additive composition is adapted to reducing the viscosity of a non-aqueous viscosified fluid.

12. A viscosified fluid composition that does not include a viscoelastic (VES) surfactant, where the viscosified fluid composition comprises:
a non-aqueous base fluid selected from the group consisting of fracturing fluids, drilling fluids, completion fluids, injection fluids, and combinations thereof; and
a first alginate anionic polysaccharide polymer derived from kelp, the polymer present in an amount effective to viscosify the non-aqueous base fluid.

13. The viscosified fluid composition of claim 12, where the fluid composition further comprises at least one breaker agent selected from the group consisting of an enzyme, a B vitamin, an oxidizer, an acid, and combinations thereof.

14. The viscosified fluid composition of claim 13, further comprising solid particles; and where the at least one breaker agent is at least one B vitamin configured to be attachable to the solid particles.

15. The viscosified fluid composition of claim 13, where the at least one breaker agent is at least one B vitamin present in an amount ranging from about 0.005 wt % to about 0.1 wt %, based on the viscosified fluid composition.

16. The viscosified fluid composition of claim 12, where the amount effective of the first alginate anionic polysaccharide polymer ranges from about 0.1 wt % to about 5 wt % of the total fluid composition.

17. The viscosified fluid composition of claim 12, where the first alginate anionic polysaccharide polymer is crosslinked by a crosslinker selected from the group consisting of gluteraldehyde, Ca⁺², Al⁺³, Fe⁺³, Ba⁺², Zr⁺⁴, Sn⁺⁴, Th⁺⁴ , U⁺⁴, La⁺³, and combinations thereof.
